(19) United States
(12) Patent Application Publication
(10) Pub. No.: US 2017/0083684 A1
(43) Pub. Date: Mar. 23, 2017

(54) PRESCRIPTION FACILITATION AND PURCHASE OPTIMIZATION PLATFORM

(71) Applicant: AuthentaScripts, Inc, Mcdonough, GA (US)

(72) Inventor: Charles Stephenson, Mcdonough, GA (US)

(21) Appl. No.: 14/859,911

(22) Filed: Sep. 21, 2015

(51) Int. Cl. G06F 19/00; G06Q 30/02

(52) U.S. Cl. CPC G06F 19/3456; G06F 19/328; G06Q 30/0283; G06F 19/3425

(57) ABSTRACT

A prescription facilitation and purchase optimization platform. The platform may provide a doctor with a doctor dashboard configured to report an electronic prescription. The platform may then receive the reported prescription and communicate the prescription to at least one pharmacist. The pharmacist, in turn, may be provided with a pharmacist dashboard configured to set a price for the prescription. The price may then be provided to the patient via a patient dashboard. The platform may further be configured to track a fulfillment of the prescription.

### FIELD OF DISCLOSURE

The present disclosure generally relates to pharmaceutical distribution and communication between doctors, pharmacists, patients, and insurance companies.

### BACKGROUND

In the present system that the medical industry uses, there is poor communication among doctors, pharmacists, patients, and insurance companies. Typically, a patient receives a paper prescription from a doctor to deliver to a pharmacist of the patient's choice. The pharmacist merely fills the prescription without interfacing directly with the doctor.

Poor communication between doctors and pharmacists leads to underutilization of the pharmacists' knowledge and skills, and can provide opportunities to for errors. Further, poor communication between pharmacists and patients may lead to overpaying for prescriptions.

Additionally, the present method for communication between pharmacists and insurance companies is a largely manual process, leading to unnecessary human interaction and errors.

### BRIEF OVERVIEW

A prescription facilitation and optimization platform may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A prescription facilitation and purchase optimization platform. The platform may provide a doctor with a doctor dashboard configured to report an electronic prescription. The platform may then receive the reported prescription and communicate the prescription to at least one pharmacist. The pharmacist, in turn, may be provided with a pharmacist dashboard configured to set a price for the prescription. The price may then be provided to the patient via a patient dashboard. The platform may further be configured to track a fulfillment of the prescription.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing embodiments of the present disclosure;

FIG. 3 illustrates a prescription;

FIG. 4 illustrates a dashboard for enabling pharmacist to create pricing structures;

FIG. 5 illustrates a dashboard 500 for enabling the pharmacist to authenticate the prescription;

FIG. 6 illustrates a dashboard 600 for providing a status for prescriptions prescribed by a doctor;

FIG. 7 is a flow chart for a method for providing communication between a pharmacist and an insurance company;

FIG. 8 illustrates a patient dashboard;

FIG. 9 shows patient dashboard 900 for enabling a patient to view his/her family and add a family member;

FIG. 10 illustrates a platform for providing information to patients including details for the patient's doctor's office; and

FIG. 11 is a block diagram of a system including a computing device for performing the methods of FIGS. 2 and 7.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header. The present disclosure includes many aspects and features. Moreover, while many aspects and features relate to, and are described in, the context of providing prescription pricing to patients, embodiments of the present disclosure are not limited to use only in this context. Embodiments of the present disclosure stems primarily from the ability to distribute information to various third-party applications, irrespective of their technologies & platforms. Therefore, embodiments may be extended further to connect doctors on a common platform. This platform may act as a centralized and shared repository with an integrated document management system. Further embodiments of the present disclosure may provide a shared view of a patient's medical records so that if a patient visits a doctor, the doctor can query the system to view the entire medical history of the patient. Furthermore, the platform may enable the doctor to add further investigations, diagnosis, prescriptions and update the system. Additionally, embodiments of the present disclosure may be utilized in business-to-business and business-to-ecommerce applications.

I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope. A prescription and facilitation and optimization platform may be used by individuals or companies to centralize and automate communication among parties to a prescription.

The platform may provide an interface between doctors, patients, pharmacists, and insurance companies. By improving communication between doctors and pharmacists, the pharmacists' knowledge base might better be utilized. For example, presently, a pharmacist has minimal access to a patient's symptoms and diagnosis; the pharmacist merely verifies the prescription and fills it. By opening communication between the pharmacist, better care might be provided to the patient.

Further, the platform may provide a platform for pharmacists to create pricing structures and provide price quotes to patients. In this way, a patient may receive a competitive price for a prescription. For example, a doctor may provide a prescription to a plurality of pharmacists via the platform. The platform may further query each pharmacists' inventory to find which pharmacists carry the necessary prescription, and receive a typical lead time for pharmacists that do not presently have the prescription. In further embodiments, the platform may provide the prescription only to pharmacists that have the prescription on-hand or have the prescription within a given lead time. The pharmacists may each create a pricing structure, as well as provide quotes for individual prescriptions (e.g., provide a reduced rate, or provide a no-quote). The prices created by the pharmacists may be provided to the patient. In some embodiments, the platform may provide patients with map or table showing the locations of pharmacists that carry their prescription as well as the corresponding price.

In further embodiments, the platform may enable the pharmacists to query the insurance company to determine an amount of coverage. The platform may automatically query an insurance company's database. Further, the platform may enable the insurance provider to verify coverage and provide additional feedback.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

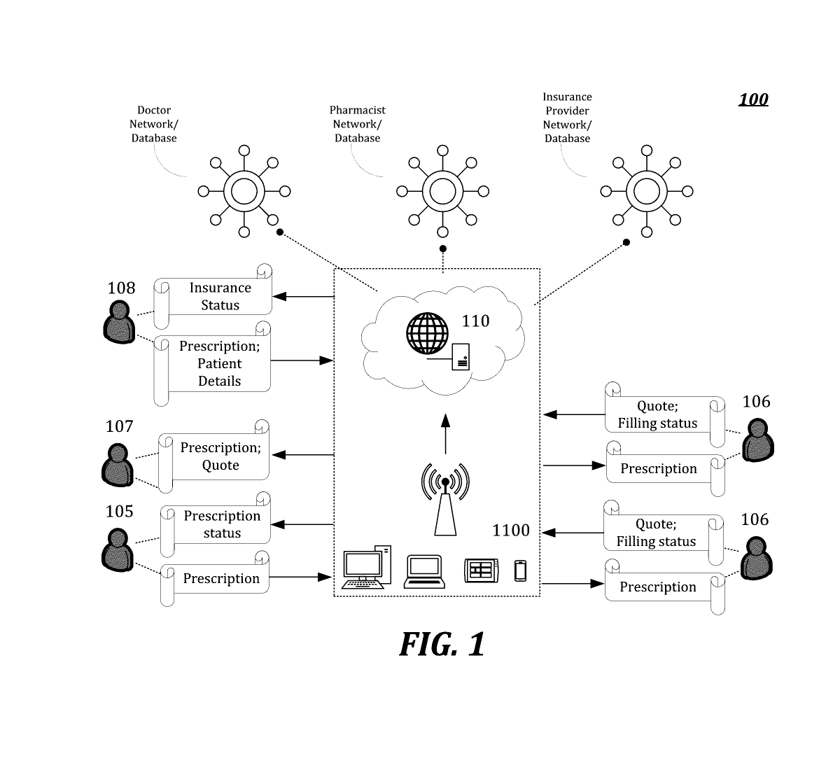

FIG. 1 illustrates one possible operating environment through which a platform consistent with embodiments of the present disclosure may be provided. By way of non-limiting example, a prescription facilitation and optimization platform 100 may be hosted on a centralized server 110, such as, for example, a cloud computing service. Doctor 105, pharmacists 106, patient 107 and insurance provider 108 (collectively ‘users’) may access platform 100 through a software application. The software application may be embodied as, for example, but not be limited to, a website, a web application, a desktop application, and a mobile application compatible with a computing device 1100. One possible embodiment of the software application may be provided by the ______™ suite of products and services provided by AuthentaScript, Inc. Each distinct user may be provided with a software application configured to provide privileges corresponding to his/her status. For example, the pharmacists 106 may be given access to dashboards for accessing prescriptions and providing quotes; a patient 107 may be given access to a dashboard for receiving prescription quotes.

Platform 100 may be configured to integrate with a plurality of clients. For example, a doctor may connect to a clinic management software using a browser/rich client or thick native client depending upon the software type. The client and the communication protocol with the server may vary depending upon the software programming technology. For example, the platform may be configured to communicate via HTTP/HTTPS, RIA/JNLP, or via native API calls. The platform may further interface with the Electronic Medical Records (EMR). Embodiments of the present disclosure may further utilize SQL code for, for example, interfacing with databases for search queries.

Embodiments of the present disclosure may comprise one or more doctor's Clinic Management Server. Clinic Management Systems integrated into the clinic management server are computer software products that coordinate and integrate all the inherent activities involved in the management and running of a healthcare facility. Connected database contains complete patient information coupled with the Electronic Medical Records (EMR).

The platform may comprise one or more broadcasters for interfacing between clinic management servers. The broadcaster is the master communicator which may reside on the clinic management server. Since the broadcaster may serve hundreds of nodes, it is built with scalability, extensibility & robustness in mind. It may accept any incoming requests from various deployed nodes distributed over the network.

The platform may further comprise nodes—thin clients deployed at pharmacy systems of pharmacists associated with embodiments of the present disclosure. Each node may act as a gateway for forwarding e-prescription to various pharmacy management software running at distributed locations.

Additionally, the platform may comprise pharmacy systems. Pharmacy Systems may be software solutions for the chain stores and independent pharmacies running in over a distributed network. A node may trigger an alert on the pharmacy system in near-real time based on a new e-prescription received over the internet. The prescription's details may be saved in the local database while a notification is forwarded to the pharmacists' UI client.

The pharmacist's user interface (UI) may vary depending upon the implementation technology; i.e. browser-based, RIA client or thick client. The notification for new prescription may appear on the client so that a pharmacist may view the details and send a quote for the drugs.

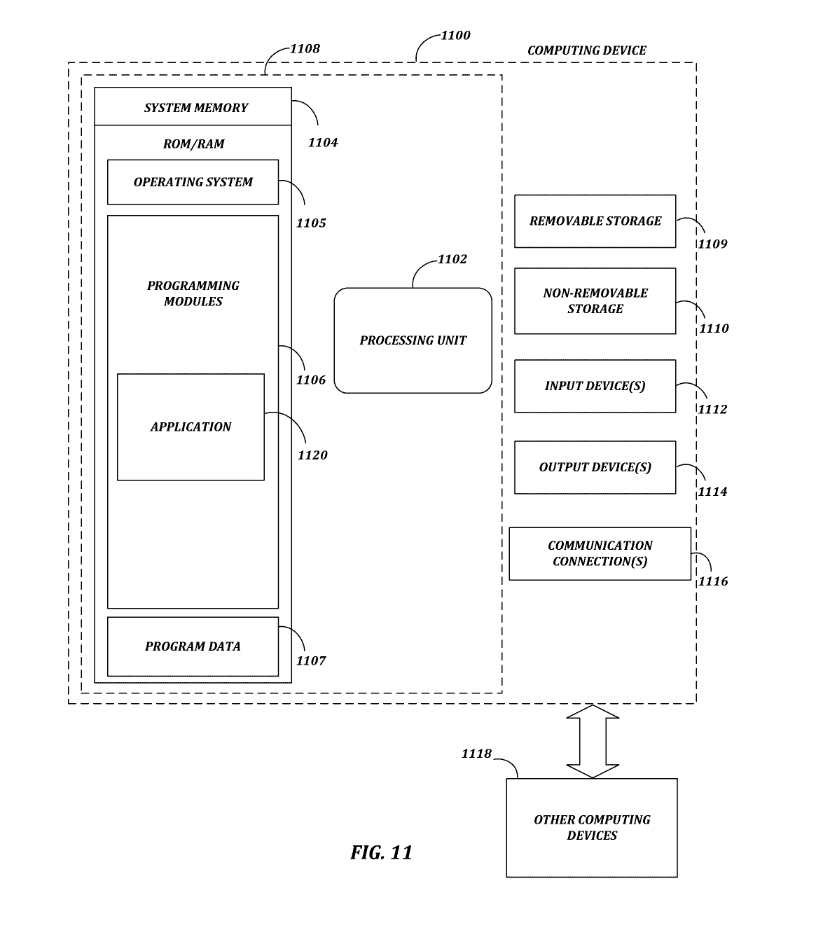

As will be detailed with reference to FIG. 11 below, the computing device through which the platform may be accessed may comprise, but not be limited to, for example, a desktop computer, laptop, a tablet, or mobile telecommunications device.

III. Platform Operation

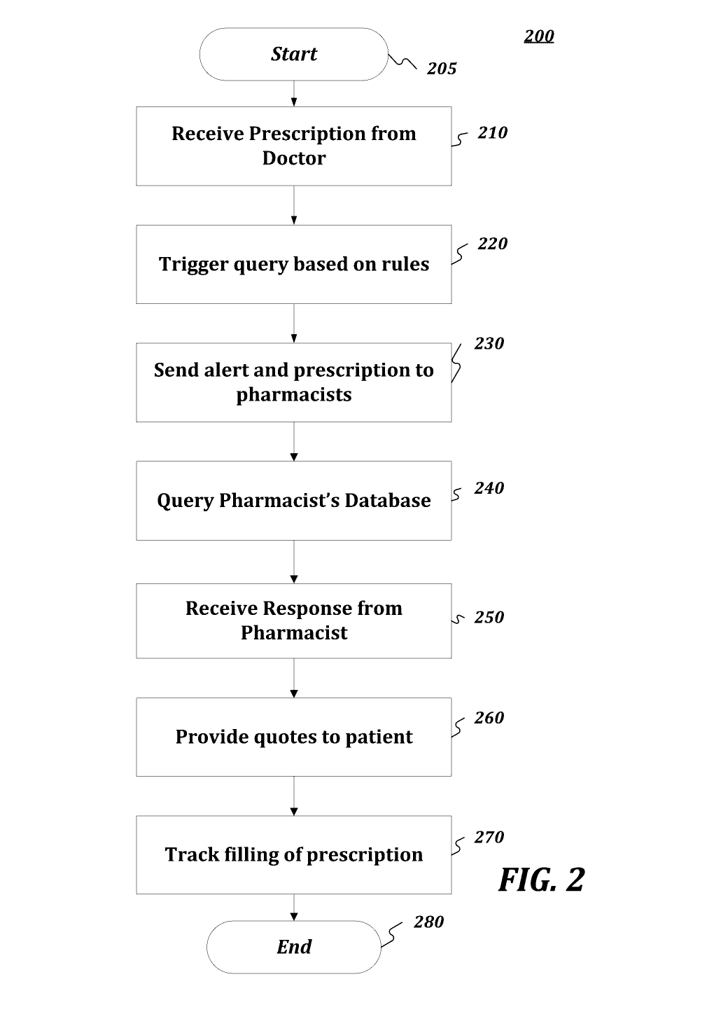

FIG. 2 is a flow chart setting forth the general stages involved in a method 200 consistent with an embodiment of the disclosure for providing a prescription facilitation and optimization platform 100. Method 200 may be implemented using a computing device 1100 as described in more detail below with respect to FIG. 11.

Although methods 200 and 700 have been described to be performed by platform 100, it should be understood that computing device 1100 may be used to perform the various stages of methods 200 and 700. Furthermore, in some embodiments, different operations may be performed by different networked elements in operative communication with computing device 1100. For example, server 110 may be employed in the performance of some or all of the stages in methods 200 and 700. Moreover, server 110 may be configured much like computing device 1100.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

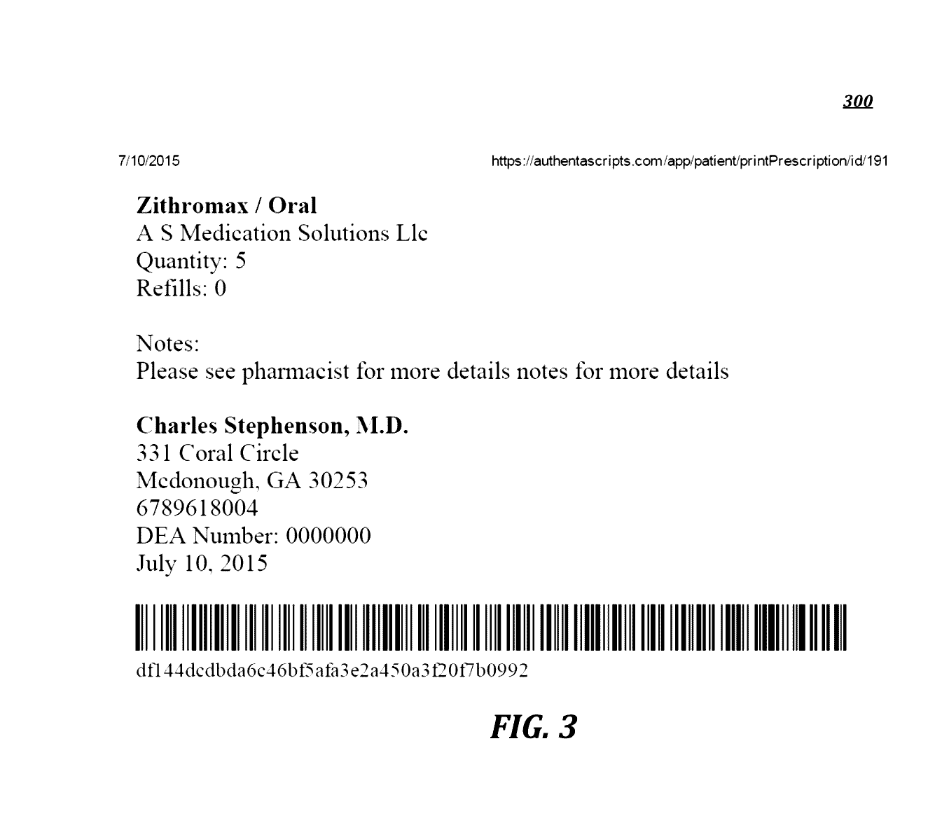

Method 200 may begin at starting block 205 and proceed to stage 210 where platform 100 may receive a prescription from a doctor. For example, the prescription may comprise an e-prescription. FIG. 3 illustrates a prescription 300 consistent with embodiments of the present disclosure. The prescription may comprise prescription details including, for example, the doctor's signature, a patient's information, drug information, doctor's notes, a DEA's number, and a barcode (e.g., a 128 bit encrypted barcode).

From stage 210, where platform 100 the platform receives the prescription from the doctor, method 200 may advance to stage 220 where platform 100 may trigger a query based on rules.

In various embodiments, the rules for this stage may be as follows. The application node may check the insurance payer's database for valid identity, insurance coverage and medication coverage formulary. If Node determines the patient's efforts for discount are sufficient, the Node may trigger a temporary formulary adjustment to insurance payer's coverage level. For example, if the medications retail price is $145.00 and the lowest negotiated price is $125.00 and the insurance payer's portion is $62.50; the insurance payers node may opt in an additional $7-12 or whatever amount the platform admin sets the rule to be. If the patient has reached a defined cap on their prescription drug coverage plan, the insurance payer's node may then roll back the rules to a lower or Nil amount which will then require the patient to negotiate the full amount of the medication.

Once platform 100 triggers a query based on the rules in stage 220, method 200 may continue to stage 230 where platform 100 may provide an alert and prescription details to at least one pharmacist. The pharmacists to whom the prescriptions are provided may comprise a pharmacist network. In some embodiments, the alert may cause an automatic search of each pharmacist's database. In further embodiments, each pharmacist may receive a notification, such as, for example, an email comprising the prescription details.

After platform 100 provides an alert and prescription details to at least one pharmacist in stage 230, method 200 may proceed to stage 240 where platform 100 may trigger a query of the at least one pharmacists' database. For example, the platform may query the pharmacist's database to determine the quantity of the prescription (i.e. drug) that the at least one pharmacist has on-hand, the lead time for obtaining the prescription, the typical cost of the prescription, etc.

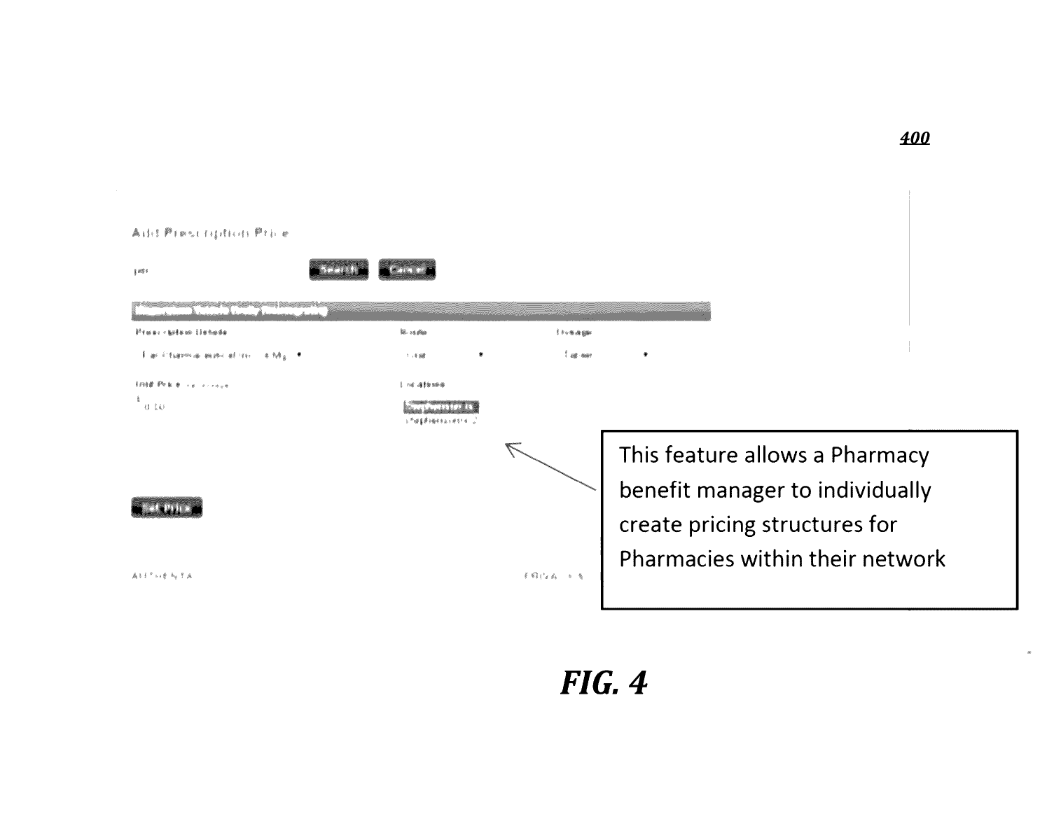

After platform 100 triggers a query of the at least one pharmacists' database in stage 240, method 200 may proceed to stage 250 where platform 100 may receive a response from at least one pharmacist. The response may include, for example, a price quote for the prescription. In some embodiments, platform 100 may enable each pharmacist to create pricing structures within his/her network. FIG. 4 illustrates a dashboard 400 for enabling pharmacist to create pricing structures. A pricing structure may include a selection of a prescription, a selection of a location, and a selection of a price (e.g., price per dosage).

After platform 100 receives a response from at least one pharmacist in stage 250, method 200 may proceed to stage 260 where platform 100 may provide quotes to the patient. In some embodiments, the quotes may be provided to the patient in a patient dashboard. The patient dashboard may display pricing information for each pharmacist that provides a quote. In some embodiments, the platform may enable reverse bidding between pharmacists so as to ensure the patient is provided with the lowest rate.

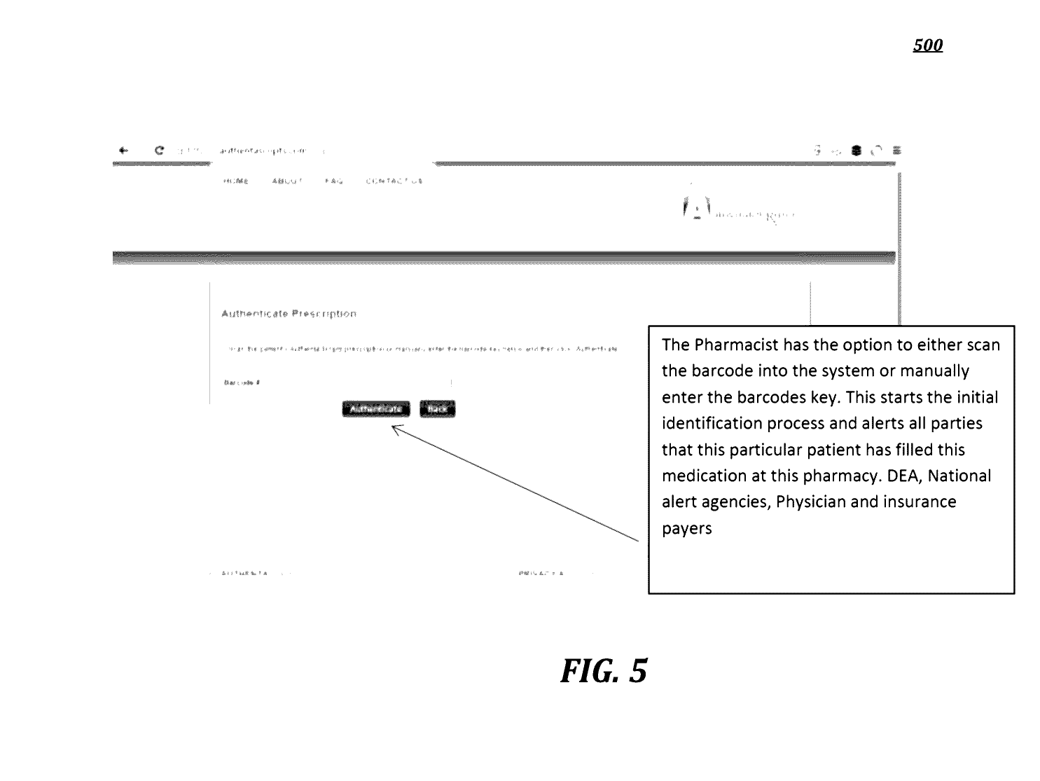

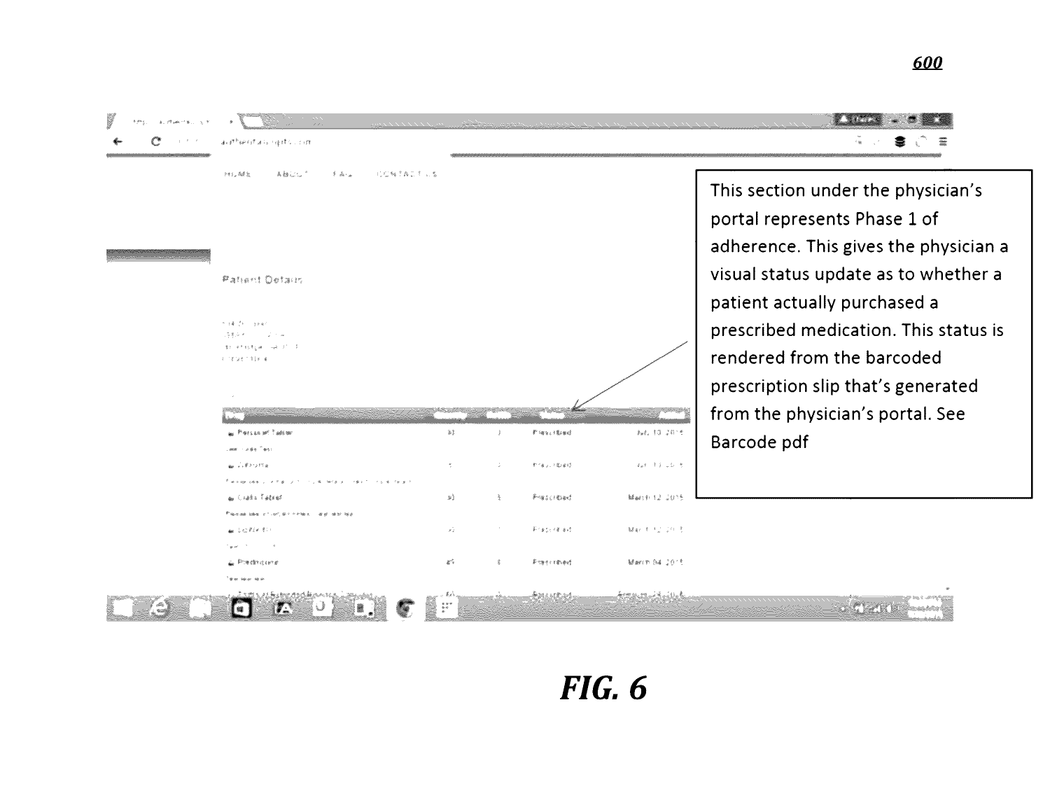

After platform 100 provides quotes to the patient in stage 260, method 200 may proceed to stage 270 where platform 100 may track a filling of the prescription. For example, the platform may enable the pharmacist to authenticate the prescription. FIG. 5 illustrates a dashboard 500 for enabling the pharmacist to authenticate the prescription. Further, upon filling the prescription, the platform may notify the doctor and other pharmacists that the prescription has been filled. FIG. 6 illustrates a dashboard 600 for providing a status for prescriptions prescribed by a doctor. Further, the platform may prevent multiple filings of the same prescription by locking the prescription after the first filing.

Once platform 100 tracks the filing of the prescription in stage 270, method 200 may then end at stage 280.

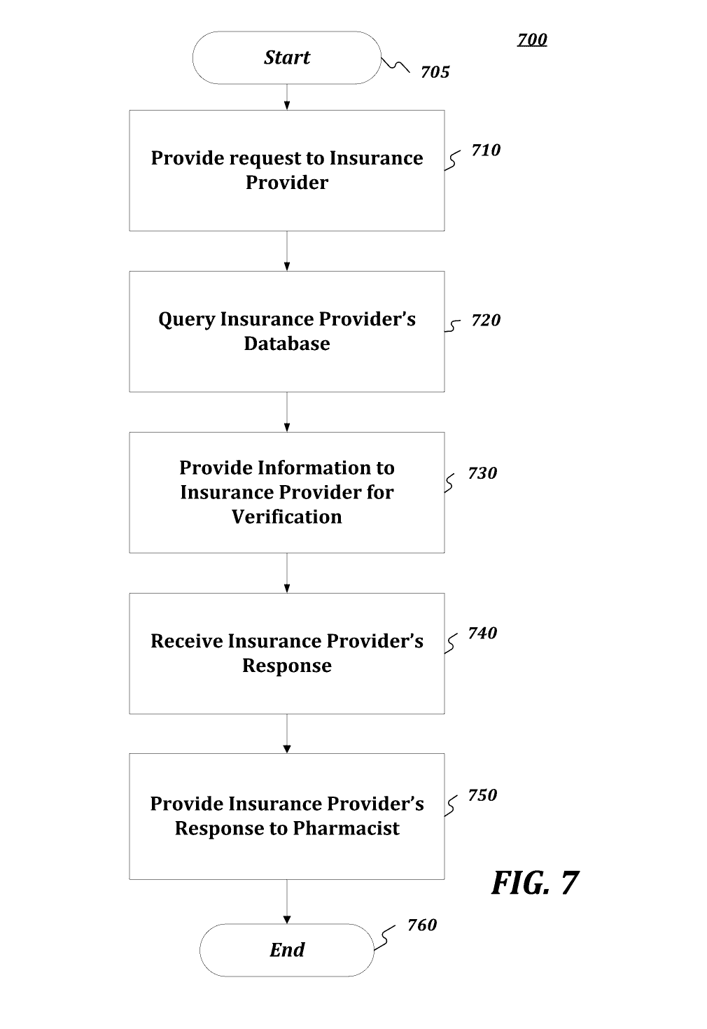

In some embodiments, the platform may further enable communication between the pharmacists and the patient's insurance provider. FIG. 7 illustrates a flow chart setting forth the general stages involved in a method 700 consistent with an embodiment of the disclosure for providing a prescription facilitation and optimization platform 100. Method 700 may be implemented using a computing device 1100 as described in more detail below with respect to FIG. 11.

Method 700 may begin at starting block 705 and proceed to stage 710 where platform 100 may provide a request to the patient's insurance provider. For example,

From stage 710, where platform 100 provides the request to the patient's insurance provider, method 700 may proceed to stage 720, where platform 100 may query the insurance provider's database.

From stage 720, where platform 100 queries the insurance provider's database, method 700 may proceed to stage 730, where platform 100 may provide information to the insurance provider for verification.

From stage 730, where platform 100 provides the information to the insurer for verification, method 700 may proceed to stage 740, where platform 100 may receive the insurer's verification.

From stage 740, where platform 100 receive the insurer's response, method 700 may proceed to stage 750, where platform 100 may provide the insurance provider's response to the pharmacist.

After providing the insurance provider's response to the pharmacist, method 700 may end at stage 760.

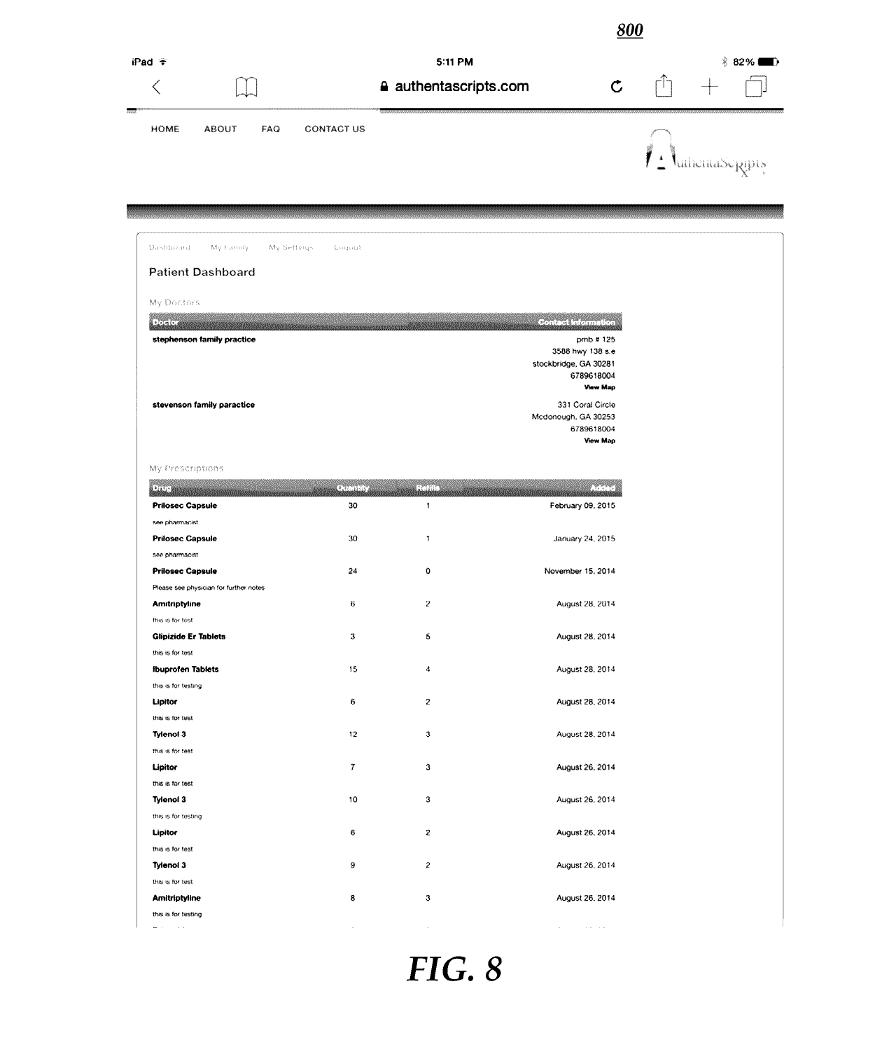

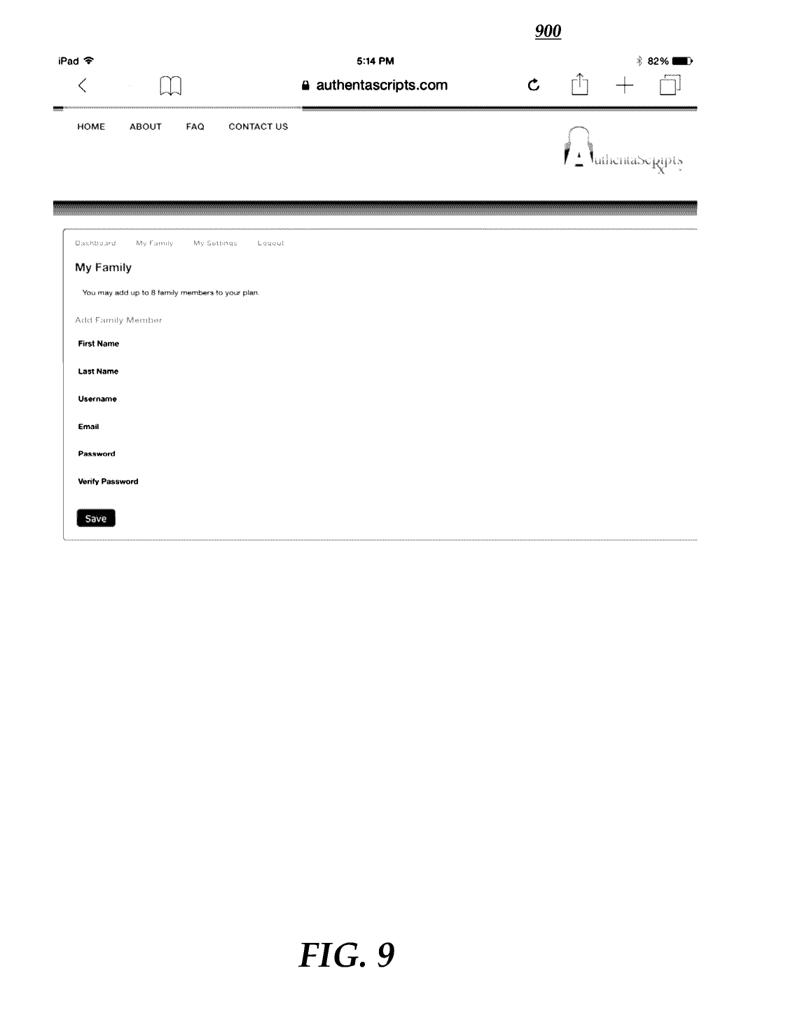

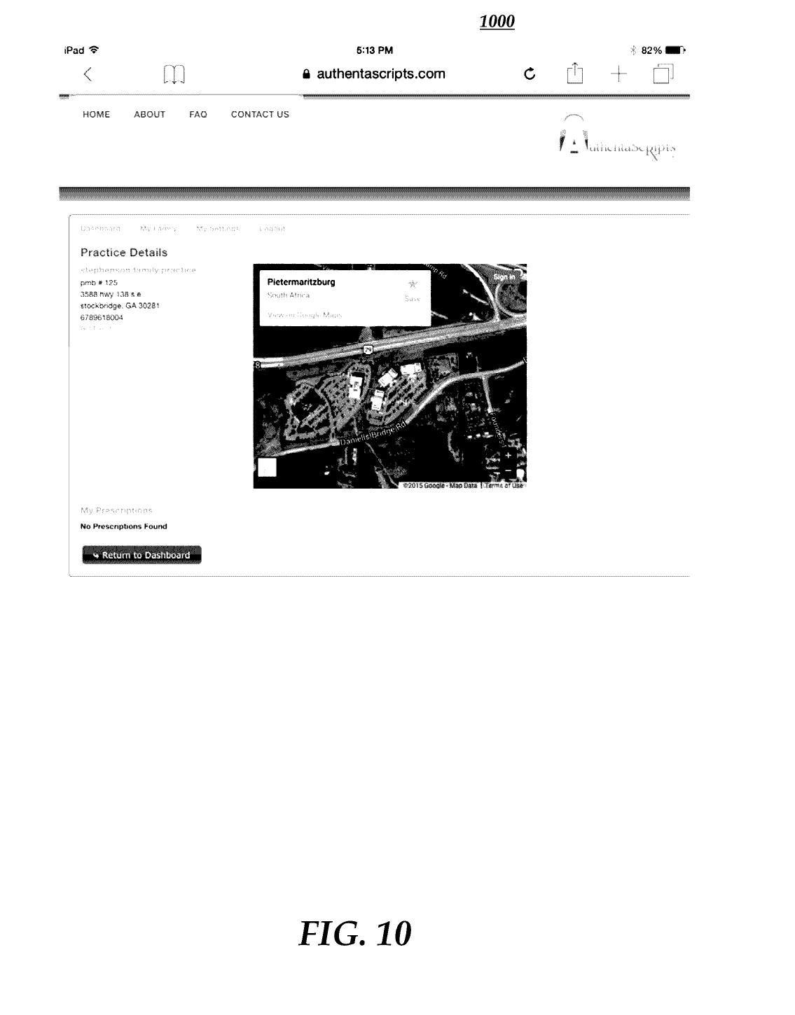

Platform 100 may further be configured to provide a patient dashboard. FIG. 8 illustrates a patient dashboard 600 consistent with embodiments of the present disclosure. The patient dashboard may enable each patient to view, for example his/her doctors and prescriptions. The patient dashboard may further enable patients to add patients to his/her account (e.g., family members). In this way, the patient may consolidate medical information. FIG. 9 shows patient dashboard 900 for enabling a patient to view his/her family and add a family member. In further embodiments, platform 100 may provide information to patients, including, for example, details for the patient's doctor's office, as shown by dashboard 1000 in FIG. 10.

IV. Platform Architecture

The prescription facilitation and optimization platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, platform 100 may be hosted on a centralized server, such as, for example, a cloud computing service. Although method 200 has been described to be performed by a computing device 1100, it should be understood that, in some embodiments, different operations may be performed by different networked elements in operative communication with computing device 1100.

Embodiments of the present disclosure may comprise a system having a memory storage and a processing unit. The processing unit may be coupled to the memory storage, wherein the processing unit is configured to perform the stages of method 200.

FIG. 11 is a block diagram of a system including computing device 1100. Consistent with an embodiment of the disclosure, the aforementioned memory storage and processing unit may be implemented in a computing device, such as computing device 1100 of FIG. 11. Any suitable combination of hardware, software, or firmware may be used to implement the memory storage and processing unit. For example, the memory storage and processing unit may be implemented with computing device 1100 or any of other computing devices 1118, in combination with computing device 1100. The aforementioned system, device, and processors are examples and other systems, devices, and processors may comprise the aforementioned memory storage and processing unit, consistent with embodiments of the disclosure.

With reference to FIG. 11, a system consistent with an embodiment of the disclosure may include a computing device, such as computing device 1100. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a program data 1107. Operating system 1105, for example, may be suitable for controlling computing device 1100's operation. In one embodiment, programming modules 1106 may include price quoting application 1120. Furthermore, embodiments of the disclosure may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated in FIG. 11 by a removable storage 1109 and a non-removable storage 1110. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

Computing device 1100 may also contain a communication connection 1116 that may allow device 1100 to communicate with other computing devices 1118, such as over a network in a distributed computing environment, for example, an intranet or the Internet. Communication connection 1116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1104, including operating system 1105. While executing on processing unit 1102, programming modules 1106 (e.g., price quoting application 1120) may perform processes including, for example, one or more of methods 200 and 700's stages as described above. The aforementioned process is an example, and processing unit 1102 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving a prescription from a doctor;
triggering a query based on rules;
sending a prescription to at least one pharmacist;
triggering a pharmacist database query;
receive a response from the at least one pharmacist, where the response comprises at least one of the following: a price quote to fill the prescription and a lead time to fill the prescription;
providing the response to a patient associated with the prescription; and
tracking a filling of the prescription.

2. The method of claim 1, wherein receiving the prescription from the doctor comprises receiving an electronic prescription comprising at least one of the following: the doctor's signature, the patient's name, a DEA's number, and a barcode.

3. The method of claim 1, further comprising:
providing the prescription to an insurance provider;
querying the insurance provider's database;
providing results from the insurance provider's database query to the insurance provider;
receiving a response from the insurance provider; and
providing the response from the insurance provider to at least one of the following: the patient, and the at least one pharmacist.

4. The method of claim 3, wherein receiving the response form the insurance provider comprises receiving an amount of coverage, wherein the amount of coverage comprises a percent coverage and a dollar-amount of coverage.

5. The method of claim 1, wherein triggering a pharmacist query comprises at least one of the following:
querying the at least one pharmacist's inventory for the prescription,
querying the at least one pharmacist's lead time for the prescription,
querying the at least one pharmacist's price for the prescription, and
querying the at least one pharmacist's ability to order the prescription.

6. The method of claim 1, wherein triggering a query comprises checking insurance payer's database for at least one of the following: valid identity, insurance coverage and medication coverage formulary.

7. The method of claim 1, further comprising:
providing a pharmacist dashboard configured to receive an authentication from the pharmacist; and
wherein tracking the filling of the prescription comprises receiving a notification of authentication upon the authentication of the pharmacist.

8. The method of claim 8, further comprising:
receiving a notification when the prescription has been filled; and
preventing further transactions from the same prescription upon receiving a notification that the prescription has been filled.

9. The method of claim 9, wherein preventing further transactions from the same prescription comprises disabling the prescription upon receiving a notification that the prescription has been filled.

10. The method of claim 9, further comprising providing the notification when the prescription has been filled to the doctor via the doctor's dashboard.

11. The method of claim 1, further comprising:
providing a pharmacist dashboard configured to receive the price quote; and
wherein receiving a response from the at least one pharmacist comprises receiving a response via the pharmacist dashboard.

12. A computer-readable medium comprising a set of instructions, which when executed perform a method comprising:
providing a doctor with a doctor dashboard configured to report an electronic prescription;
receiving the prescription from the doctor via the doctor dashboard;
communicating the prescription to at least one pharmacist based on the query;
providing the at least one pharmacist with a pharmacist dashboard configured to set a price for the prescription;
providing the price to the patient via a patient dashboard; and
facilitating a transaction, via the patient dashboard; and
tracking a fulfillment of the prescription.

13. The computer-readable medium of claim 12, further comprising:
providing the prescription to an insurance provider;
querying the insurance provider's database;
providing results from the insurance provider's database query to the insurance provider;
receiving a response from the insurance provider; and

14. The computer-readable medium of claim 12, further comprising trigger a query to a pharmacist's database, wherein triggering the query comprises at least one of the following: querying the at least one pharmacist's inventory for the prescription; querying the at least one pharmacist's lead time for the prescription; querying the at least one pharmacist's price for the prescription; and querying the at least one pharmacist's ability to order the prescription.

15. The computer-readable medium of claim 12, wherein triggering a query comprises checking insurance payer's database for at least one of the following: valid identity, insurance coverage and medication coverage formulary.

16. The computer-readable medium of claim 12, wherein tracking the fulfillment of the prescription comprises:
receiving a notification when the prescription has been filled; and
preventing further transactions from the same prescription upon receiving a notification that the prescription has been filled.

17. A system comprising:
a memory storage; and
a processing unit configured to:
provide a doctor with a doctor dashboard configured to report an electronic prescription;
receive the prescription from the doctor via the doctor dashboard;
communicate the prescription to at least one pharmacist based on the query;
provide the at least one pharmacist with a pharmacist dashboard configured to set a price for the prescription; and
provide the price to the patient via a patient dashboard.

18. The system of claim 18, further comprising trigger a query to a pharmacist's database, wherein triggering the query to the at least one pharmacist's database comprises at least one of the following: a query of the at least one pharmacist's inventory for the prescription; a query of the at least one pharmacist's lead time for the prescription; a query of the at least one pharmacist's price for the prescription; and a query of the at least one pharmacist's ability to order the prescription.

19. The system of claim 18, wherein the processing unit is further operative to:
provide the prescription to an insurance provider;
query the insurance provider's database;
provide results from the insurance provider's database query to the insurance provider;
receive a response from the insurance provider; and
provide the response from the insurance provider to at least one of the following: the patient, and the at least one pharmacist.

20. The system of claim 18, wherein the processing unit is further operative to:
provide a pharmacist dashboard configured to receive an authentication from the pharmacist; and
provide a notification to the doctor via the doctor dashboard upon receipt of the authentication from the pharmacist.
